(19) United States
(12) Patent Application Publication
(10) Pub. No.: US 2005/0210729 A1
(43) Pub. Date: Sep. 29, 2005

(54) Fishing reel threading tool

(76) Inventor: Harry John Maxwell, Navarre, FL (US)

Correspondence Address: JOHN MAXWELL, 1830 EAGLE LN, NAVARRE, FL, 32566, US

(21) Appl. No.: 10/708,789

(22) Filed: Mar. 25, 2004

(51) Int. Cl. A01K 91/00

(52) U.S. Cl. 43/4

(57) ABSTRACT

The fishing reel threading tool provides an easy method of threading fishing line through the level wind orifice of fishing reels. Many level wind reels are designed in a way that makes threading fishing line through the front of the fishing reel a difficult and frustrating task. The fishing reel threading tool consists of a handle with a flexible modified loop at one end. The fishing reel threading tool is inserted through the front of the fishing reel over or beyond the fishing reel spool. After a length of fishing line is inserted into the flexible modified loop, the tool and the end of the fishing line stored on the reel spool are extracted from the fishing reel. In addition to the design aspects of level wind reels, the task can be aggravated when the fishing line assumes curl memory of the fishing reel spool, when there is significant wind, when threading the reel is attempted on a rocking watercraft, when the reel is spooled with small diameter or low visibility fishing line, in poor light conditions, or when the fisherman has impaired vision. The fishing reel threading tool floats for an adequate period of time to allow recovery should the tool fall in water The compact size of the fishing reel threading tool makes it easy to store in a tackle box, on a boat, or in the fisherman's pocket.

### BACKGROUND OF INVENTION

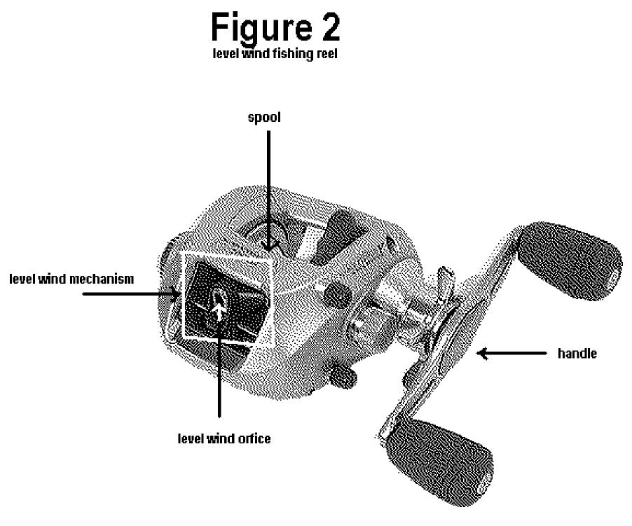

Many fishing reels have been produced that use level wind mechanisms to perform the function of distributing fishing line evenly on the fishing reel spool (FIG. 2). The level wind mechanism generally consists of a gear driven orifice (FIG. 2) that moves laterally back and forth in front of the rotating reel spool that stores the fishing line (FIG. 2). The fishing reel retrieves the fishing line through the use of a handle and gears that rotate the spool and further drive the level wind mechanism. The design of many level wind fishing reels places the level wind orifice (FIG. 2) and reel spool in positions that makes threading fishing line, from the fishing reel spool through the level wind orifice, awkward and difficult.

The difficulty in threading fishing line through the level wind orifice is further complicated by the tendency of many types of fishing line to acquire a curled shape, commonly called memory, after being placed on fishing reel spool.

The ability to thread fishing line through the level wind orifice is also impacted by windy conditions, low light conditions, poor eye sight, rough water when a person is a passenger on a watercraft, and by the intentional efforts of fishing line manufacturers to make fishing lines less visible to fish.

### DETAILED DESCRIPTION

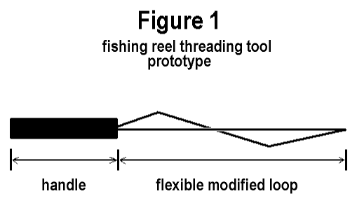

The fishing reel threading tool (FIG. 1) is a handheld device used to thread fishing line through the level wind orifice of a fishing reel (FIG. 2). The level wind orifice is described herein as the opening in the level wind mechanism (FIG. 2) that guides the fishing line on to the fishing reel spool (FIG. 2). The tool consists of handle that is long enough to fit comfortably between the thumb and forefinger with a flexible modified loop extending from one end. The handle and flexible modified loop are made from a material or materials of adequate flexibility and strength to hold up to the fishing line extraction process. The fishing reel threading tool will float for an adequate period of time to allow for recovery should it fall into water. The modified loop extension has a tip designed to compress while being inserted through the small passage in the level wind orifice then expand to permit easy insertion of the end of the fishing line that is stored on the fishing reel spool.

1. A tool to assist fisherman in threading fishing line through the level wind mechanism on level wind equipped fishing reels.
The tool consists of a handle with a flexible modified loop that is an integral part of, or securely attached to, one end of the handle.

2. The tool of claim 1 is held by the handle as the flexible modified loop is inserted through the front of the fishing reel level wind orifice.
A small length of fishing line from the fishing reel spool, that is free from tangle or constraint, is inserted into the exposed end of modified loop extension.
As the tool is extracted from the fishing reel level wind mechanism, the loop collapses around the fishing line as the fishing line is pulled through the level wind orifice.

3. The tool of claim 1 is made from a material or materials suitable for use both fresh and saltwater environments and will float for an adequate period of time to allow recovery should the tool fall into water.
